(19) United States
(12) Patent Application Publication
(10) Pub. No.: US 2026/0234747 A1
(43) Pub. Date: Aug. 13, 2026

(54) Method For Treating Phosphate Ores Containing Heavy Metals By Reverse Flotation

(71) Applicants: Universite Mohammed VI Polytechnique, Benguerir (MA); OCP SA, Casablanca (MA)

(72) Inventors: Rachid Benhida, Nice (FR); Zakaria Moutaoukil, Marrakech (MA); Moulay Brahim Jouti, Khouribga (MA); Cyril Ronco, Nice (FR); Zouhair Hafid, Casablanca (MA)

(73) Assignees: Universite Mohammed VI Polytechnique, Benguerir (MA); OCP SA, Casablanca (MA)

(21) Appl. No.: 19/156,669

(22) PCT Filed: Feb. 15, 2024
(86) PCT No.: PCT/MA2024/050004

§ 371 Date: Aug. 14, 2025

(30) Foreign Application Priority Data
Feb. 15, 2023 (EP) 23305204.2

(51) Int. Cl. C22B 3/16; B03D 1/008; B03D 1/014; B03D 1/02

(52) U.S. Cl. CPC C22B 3/1616; B03D 1/008; B03D 1/014; B03D 1/021; B03D 2201/02; B03D 2203/06

(57) ABSTRACT

The present disclosure relates to a method for treating phosphate ores containing heavy metals by reverse flotation. The method comprises adding, to an aqueous suspension of phosphate ore, a monophosphoric ester A of formula (I), R₁—O—P(═O)—(OH)₂ (I), wherein R₁ is a saturated or unsaturated, linear or branched hydrocarbon chain comprising 6 to 10 carbon atoms, preferably an alkyl group, alone or mixed with a compound B chosen from the group consisting of a monophosphoric ester of formula (II), R₂—O—P(═O)—(OH)₂ (II), wherein R₂ is a saturated or unsaturated, linear or branched hydrocarbon chain comprising 6 to 18 carbon atoms, preferably an alkyl group, different from the group R₁ of the monophosphoric ester A of formula (I), an alcohol, a fatty acid, a fixed oil, a sulphate, a sulphonate, an ether and mixtures thereof.

### TECHNICAL FIELD OF THE INVENTION

The present invention relates to a method for treating phosphate ores containing heavy metals by reverse flotation in which a monophosphoric ester is used as a collector for the flotation of carbonates. The method according to the invention allows to reduce the heavy metal content of phosphate ores.

### STATE OF THE ART

Global consumption of phosphates, mainly for the production of phosphoric acid and fertilizers (95%), exceeded 47 million tonnes in 2019 and is expected to reach more than 50 million tonnes in 2023 (USGS). Phosphates are produced by mining phosphoric rocks collected from marine sediment deposits (75%), igneous and metamorphic deposits (15 to 20%), or biogenetic deposits (2 to 3%). The main source of phosphates comes from calcium phosphate apatite ores (Cas(PO₄)₃) (F, Cl, OH), whose global reserves are mainly present in North Africa (Morocco), the United States (Florida), Russia, and China. These ores represent approximately 80% of the total global production of phosphate rocks and generally contain between 18% and 35% P₂O₅. The predominant types of apatites in these ores are Francolite or Colophane, which contain in addition to calcium phosphate variable amounts of carbonates (such as calcite, dolomite or magnesite), silicates, clays (illite, kaolinite, smectite, etc.) or even organic residues.

Phosphate ore treatment techniques depend primarily on the type of associated gangue minerals present in the extracted rock. The historical beneficiation method used for half a century has been froth flotation. Sedimentary phosphate ore may contain either carbonate gangue or siliceous and/or silico-carbonate gangue. Silica and phosphates have significantly different physicochemical properties and can be easily separated by flotation. On the other hand, carbonates and phosphates have similar physicochemical properties and behave similarly during flotation operations; they are both found as either floated or depressed products.

Typically, the ore is first crushed and suspended in water. Then, the collector is added, often in combination with other additives, such as frothers, pH regulators, dispersants, depressants, and/or stimulants (activators), to separate the valuable minerals from the ore gangue minerals. After a conditioning period, the flotation process then begins, which involves blowing air into the suspension to break up the fine ore particles and produce froth on the surface. Three types of phosphate flotation methods have been developed in the industry to upgrade ores: direct flotation, reverse flotation, and the Crago method. In a direct flotation method, the collector makes the surface of the minerals more hydrophobic, while the hydrophilic gangue minerals do not adhere to the gas bubbles and remain in solution. The froth from the mineral collector is then removed and treated. In a reverse flotation method, the valuable minerals in the ore remain in solution and the gangues are carried away in the froth, which is then removed. The Crago method, on the other hand, uses coarse flotation with fatty acids followed by flotation by deoiling and cleaning with amines.

The purpose of these flotation methods is to enrich the mixture with valuable minerals with the best possible yield. In order to meet the growing demand for phosphate rocks and the progressive depletion of global high-grade phosphate reserves, industries are therefore encouraged to improve enrichment technologies to valorize phosphate ores with lower P₂O₅ content.

The removal of carbonates from phosphate ore has proven particularly difficult, and various nonionic, anionic, and cationic surfactants have been proposed as collectors.

Fatty acid-based collector systems are generally used to increase the hydrophobicity differences between the material to be retained and the material to be removed. The main primary collectors are based on partially unsaturated fatty acids (C12-C18), which are used at pH 4-5, with phosphoric acid as a depressant. Since fatty acids are poorly soluble in water at this pH, secondary collectors, usually anionic or nonionic surfactants, are used to improve selectivity and recovery.

Application WO2018197476 thus describes a mixture of unsaturated fatty acids, pegylated alcohol and a sulfide-based surfactant used at a dose of 500 g/t and in a pH range of 4.9 to 5.2.

A mixture of a fatty acid and an aromatic sulfonic acid used at a dose of 806 g/t and in a pH range of 5.0 to 5.2 is described in application WO210162344.

U.S. Pat. No. 8,657,118B2 describes a reverse flotation method using mixtures of phosphoric monoester and phosphoric diester at contents of 340 g/t and 500 g/tonnes in order to enrich the ores in P₂O₅.

Prior art reverse flotation methods have many disadvantages. They may involve the use of frothers, pH regulating agents, or activating agents. In particular, these methods require large amounts of collectors and involve operating in an acid pH range.

Moreover, the ores to be treated may contain elements that can pollute the soil or water tables, such as cadmium (Cd), copper (Cu), arsenic (As), lead (Pb), nickel (Ni) or else chromium (Cr).

Cadmium levels in fertilizers are under particular scrutiny by the European Parliament and other institutions, which require limits on cadmium in phosphate fertilizers. Hence the importance of reducing the concentration of Cd, as well as other heavy metals, such as arsenic.

Overall, reverse flotation of siliceous and calcareous sedimentary phosphates remains an ongoing industrial challenge. Therefore, finding a suitable collector and/or formulation combining efficient silico-carbonate removal, good flotation yields, and manageable froth properties remains a high priority in this field.

Calcite increases sulfuric acid consumption in the manufacture of phosphoric acid and fertilizers, and significant levels of toxic impurities have been identified in dolomite ores. Therefore, despite several advances made in recent years to address these issues, improvements are still needed in the phosphoric rock flotation process.

There is therefore a need for new, simpler and less expensive methods for treating phosphate ores, enabling their P₂O₅ content to be enriched but also their content of heavy metals, such as cadmium and arsenic, to be reduced.

### SUMMARY OF THE INVENTION

The present invention relates to a method for treating phosphate ores containing heavy metals by reverse flotation, the method comprising the following steps:
(i) adding, to an aqueous suspension of phosphate ore, a monophosphoric ester A of formula (I):

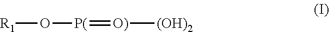

wherein R₁ is a saturated or unsaturated, linear or branched hydrocarbon chain, comprising 6 to 10 carbon atoms, preferably an alkyl group, alone or mixed with a compound B chosen from the group consisting of:
   a monophosphoric ester of formula (II)

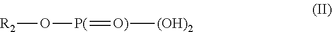

wherein R₂ is a saturated or unsaturated, linear or branched hydrocarbon chain, comprising 6 to 18 carbon atoms, preferably an alkyl group, different from the group R₁ of the monophosphoric ester A of formula (I),
an alcohol, a fatty acid, a fixed oil, a sulfate, a sulfonate, an ether, and mixtures thereof;
(ii) injecting gas into the aqueous suspension to form froth; and
(iii) removing froth and recovering the aqueous suspension of treated ore.

The present invention also relates to the use of such a monophosphoric ester A, alone or in combination with compound B as described herein, for the treatment of phosphate ores containing heavy metals.

Other aspects of the invention are as described below and in the claims.

### FIGURES

FIG. 1: Example of a laboratory-scale flotation column

### DETAILED DESCRIPTION OF THE INVENTION

The inventors have developed a method that meets the expressed needs. The proposed method does not have the disadvantages of the prior art. It allows to increase the P₂O₅ content of the ore by using a smaller amount of collector. It also allows to reduce the heavy metal content of the ore, in particular cadmium and arsenic.

The various embodiments presented throughout the description may be used alone or in combination with each other, without limitation of combination.

Thus, the invention relates to a method for treating phosphate ores containing heavy metals by reverse flotation, the method comprising the following steps:
(i) adding, to an aqueous suspension of phosphate ore, a monophosphoric ester A of formula (I):

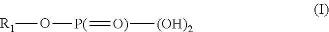

wherein R₁ is a saturated or unsaturated, linear or branched hydrocarbon chain, comprising 6 to 10 carbon atoms, preferably an alkyl group, alone or mixed with a compound B chosen from the group consisting of:
   a monophosphoric ester of formula (II):

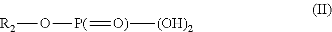

wherein R₂ is a saturated or unsaturated, linear or branched hydrocarbon chain, comprising 6 to 18 carbon atoms, preferably an alkyl group, different from the group R₁ of the monophosphoric ester A of formula (I),
an alcohol, a fatty acid, a fixed oil, a sulfate, a sulfonate, an ether, and mixtures thereof;
(ii) injecting gas into the aqueous suspension to form froth; and
(iii) removing froth and recovering the treated ore aqueous suspension.

Advantageously, the treatment method according to the invention allows to reduce the content of heavy metals present in phosphate ores such as Cadmium, Arsenic, Lead, Nickel, Chromium, Copper and Zinc, in particular Cadmium and Arsenic.

In particular, the method according to the invention can allow to eliminate at least 60% by weight of the heavy metals present in the phosphate ore. Advantageously at least 70% by weight of the heavy metals are eliminated, particularly advantageously at least 80% of the heavy metals are eliminated.

In particular, the method according to the invention allows to eliminate at least 60% by weight of the cadmium and arsenic present in the phosphate ore, advantageously at least 70% by weight of the cadmium and arsenic are eliminated, particularly advantageously, at least 80% of the cadmium and arsenic are eliminated.

The advantages of the method according to the invention make it particularly applicable to the treatment of phosphate ores on an industrial scale.

### Step (i)

Step (i) comprises adding, to an aqueous suspension of phosphate ore, a monophosphoric ester A of formula (I):

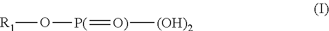

wherein R₁ is a saturated or unsaturated, linear or branched hydrocarbon chain, comprising 6 to 10 carbon atoms, preferably an alkyl group,
   alone or mixed with a compound B chosen from the group consisting of:
a monophosphoric ester of formula (II):

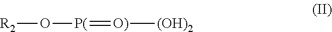

wherein R₂ is a saturated or unsaturated, linear or branched hydrocarbon chain, comprising 6 to 18 carbon atoms, preferably 6 to 10 carbon atoms, preferentially an alkyl group, different from the group R₁ of the monophosphoric ester A of formula (I),
an alcohol, a fatty acid, a fixed oil, a sulfate, a sulfonate, an ether and mixtures thereof.

### Aqueous Suspension of Phosphate Ore

Phosphate ore, also called “phosphate rock”, refers to an exogenous rock containing phosphate. The phosphate ore useful in the present invention can be taken from the Khouribga site (Bni-Amir), Morocco.

Typically, phosphate ore has a P₂O₅ content ranging from 18 to 35%, by weight, relative to the total weight of the phosphate ore.

The aqueous suspension is typically prepared by mixing phosphate ore with water. The phosphate ore is in the form of particles. Advantageously, the ore particles have a size ranging from 40 μm to 125 μm, or from 40 am to 160 μm. The particle size is determined by sieving. Thus, before mixing with water, the phosphate ore is typically pre-ground and sized.

The mass percentage of phosphate ore in the aqueous suspension, also called pulp, typically varies from 10% to 30%, preferably from 10% to 20%, the percentage being expressed as a % by weight relative to the total weight of the phosphate ore suspension.

Monophosphoric ester A of formula (I), alone or in mixture with the compound B, acts as a “collector” for the flotation of carbonates.

The “collector” has the ability to adsorb on the surface of the carbonate particles present in the phosphate ore, then allowing their separation and elimination during subsequent steps of the method.

The “collector” will also form a complex with the heavy metals present in the ore, said complex then being at least partly eliminated during the subsequent steps of the method.

### Monophosphoric Ester A

The nature of the hydrocarbon chain, preferably of the alkyl group, in particular the length of the hydrocarbon chain, preferably of the alkyl chain and the presence of branches, can influence the ability of the monophosphoric ester to interact with the carbonates and heavy metals present in the phosphate ore.

The group R₁ of the monophosphoric ester A of formula (I) is saturated or unsaturated, linear or branched hydrocarbon chain comprising 6 to 10 carbon atoms, preferably an alkyl group.

Advantageously, the group R₁ of the monophosphoric ester A of formula (I) is a linear alkyl group comprising 6 to 10 carbon atoms, preferably 7 to 10 carbon atoms, preferably 8 to 9 carbon atoms, particularly preferably comprising 8 carbon atoms.

Advantageously, the group R₁ of the monophosphoric ester A of formula (I) is a branched alkyl group comprising 6 to 10 carbon atoms, preferably 8 to 9 carbon atoms.

Preferred branched groups R₁ include 2-ethylhexyl, 2-4-4 trimethylpentyl and 3-5-5 trimethylhexyl.

Advantageously, the group R₁ of the monophosphoric ester A of formula (I) is a linear alkyl group comprising 8 or 9 carbon atoms or a branched alkyl group comprising 8 or 9 carbon atoms.

According to certain embodiments, the collector consists of the monophosphoric ester A of formula (I) as described above.

At an equivalent number of carbons, the presence of branches on the hydrocarbon chain, preferentially of the alkyl group, of the group R₁ of the monophosphoric ester A can then allow to minimize the amount of froth (also called float) which is eliminated during step (iv) of the method while allowing to enrich the ore in P₂O₅ and to eliminate heavy metals.

### Combination of Monophosphoric Ester a and Compound B

The combination of a monophosphoric ester A and the compound B can also have an influence on the amount of froth formed and the enrichment of the ore in P₂O₅.

When the compound B is present, it is chosen from the group consisting of:
a monophosphoric ester of formula (II):

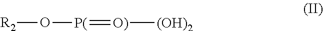

wherein R₂ is a saturated or unsaturated, linear or branched hydrocarbon chain, having from 6 to 18 carbon atoms, preferably from 6 to 10 carbon atoms, preferentially an alkyl group, different from the group R₁ of the monophosphoric ester A of formula (I) as described above,
an alcohol, a fatty acid, a fixed oil, a sulfate, a sulfonate, an ether and mixtures thereof.

The combination of the monophosphoric ester A and the compound B can minimize the amount of froth (float) that is removed in step (iv) of the method while enriching the ore in P₂O₅ and removing heavy metals, compared to the use of monophosphoric ester A alone. Furthermore, the cost of the composition comprising monophosphoric ester A and compound B can also be reduced.

### Combination of Monophosphoric Ester a and Monophosphoric Ester of Formula (II)

According to embodiments, compound B is a monophosphoric ester of formula (II):

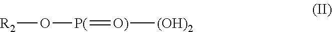

in which the group R₂, different from R₁, is a saturated or unsaturated, linear or branched hydrocarbon chain comprising 6 to 18 carbon atoms, preferably 6 to 14 carbon atoms, particularly preferably 6 to 10 carbon atoms, preferably an alkyl group.

In certain embodiments, the group R₁ of the monophosphoric ester A of formula (I) is a linear alkyl group comprising 6 to 10 carbon atoms and the group R₂ of the monophosphoric ester B of formula (II), different from R₁, is saturated or unsaturated, linear or branched hydrocarbon chain comprising 6 to 10 carbon atoms, preferably a linear alkyl group comprising 6 to 10 carbon atoms.

In certain embodiments, the group R₁ of the monophosphoric ester A of formula (I) is a linear alkyl group comprising 6 to 10 carbon atoms and the group R₂ of the monophosphoric ester B of formula (II), different from R₁, is a branched alkyl group comprising 6 to 10 carbon atoms.

Preferably, the group R₁ of the monophosphoric ester A of formula (I) is a linear alkyl group comprising 7 to 10 carbon atoms, preferably 8 to 9 carbon atoms, particularly preferably comprising 8 carbon atoms and the group R₂ of the monophosphoric ester B of formula (II), different from R₁, is a branched alkyl group comprising 8 or 9 carbon atoms.

A synergistic effect related to the combination of the two monophosphoric esters can be observed, in particular concerning the enrichment of the ore in P₂O₅.

### Combination of Monophosphoric Ester A and Alcohol

According to certain embodiments, compound B is an alcohol of formula R₃—OH (III), R₃ being saturated or unsaturated, linear or branched hydrocarbon chain comprising 2 to 20 carbon atoms, preferably 6 to 10 carbon atoms, particularly preferably 8 to 10 carbon atoms, preferably an alkyl group.

Preferably, the group R₁ of the monophosphoric ester A of formula (I) is a linear alkyl group comprising 7 to 10 carbon atoms, preferably 8 to 9 carbon atoms, particularly preferably comprising 8 carbon atoms and the group R₃ of the alcohol of formula (III) is a linear alkyl group comprising from 6 to 10 carbon atoms, preferably from 8 to 10 carbon atoms.

Advantageously, the mass percentage of alcohol is less than 70%, preferably less than 50%, preferably less than 40%, preferably less than 30% relative to the mass of the monophosphoric ester A and the alcohol.

### Combination of Monophosphoric Ester A and Sulfate or Sulfonate

According to certain embodiments, the compound B is a salt of a hydrocarbon chain sulfonic acid, or a salt of an aromatic sulfonic acid substituted by a hydrocarbon chain, the hydrocarbon chain being saturated or unsaturated, linear or branched, comprising 2 to 20 carbon atoms, preferably an alkyl group. Preferably, the compound B is a salt of an alkylated aromatic sulfonic acid, the alkyl group being linear and comprising 10 to 14 carbon atoms, the sodium salt of dodecyl benzene sulfonic acid being particularly preferred.

The compound B may be a sulfate with a saturated or unsaturated, linear or branched hydrocarbon chain, comprising 2 to 20 carbon atoms, preferably an alkyl sulfate.

Preferably, the alkyl group is linear and comprises 10 to 14 carbon atoms, sodium dodecyl sulfate being particularly preferred.

Preferably, the group R₁ of the monophosphoric ester A of formula (I) is a linear alkyl group comprising 7 to 10 carbon atoms, preferably 8 to 9 carbon atoms, particularly preferably comprising 8 carbon atoms and the compound B is a salt of an alkylated aromatic sulfonic acid, the alkyl group being linear and comprising 10 to 14 carbon atoms.

Preferably, the group R₁ of the monophosphoric ester A of formula (I) is a linear alkyl group comprising 7 to 10 carbon atoms, preferably 8 to 9 carbon atoms, particularly preferably comprising 8 carbon atoms and the compound B is an alkyl sulfate, the alkyl group being linear and comprising 10 to 14 carbon atoms.

Advantageously, the mass percentage of the alkylated sulfonic acid salt or the alkylated aromatic sulfonic acid salt is less than or equal to 40% relative to the mass of the monophosphoric ester A and the alkylated sulfonic acid salt or the alkylated aromatic sulfonic acid salt.

Advantageously, the mass percentage of the alkyl sulfate is less than 70%, preferably less than 50%, preferably 40%, preferably 30%, preferably 20% relative to the mass of the monophosphoric ester A and the alkyl sulfate.

### Combination of Monophosphoric Ester a and Ether

According to certain embodiments, the compound B is an ether, pegylated or not, of formula R₅—(OC₂H₄)ₙO—R₆ (IV) with R₅ being an alkyl or aromatic or alkylated aromatic group and R₆ being an alkyl group or a hydrogen atom and n represents an integer ranging from 0 to 10.

The term “alkylated aromatic” means an aromatic group substituted by a linear or branched alkyl group comprising from 2 to 20 carbon atoms.

Preferably, R₅ is an alkylated aromatic group, R₆ is a hydrogen atom and n is different from zero.

Preferably, R₅ is an aromatic group substituted by a branched alkyl group carrying 6 to 10 carbon atoms, R₆ is a hydrogen atom and n is different from zero.

According to certain embodiments, the compound B is an ether, pegylated or not, of formula R₅—(OC₂H₄)ₙO—R₆ (IV) with R₅ being an unsaturated hydrocarbon chain or an aromatic group substituted by an unsaturated hydrocarbon chain and R₆ being an unsaturated hydrocarbon chain or a hydrogen atom and n represents an integer ranging from 0 to 10.

Preferably, the group R₁ of the monophosphoric ester A of formula (I) is a linear alkyl group comprising 7 to 10 carbon atoms, preferably 8 to 9 carbon atoms, particularly preferably comprising 8 carbon atoms and the compound B is a compound of formula (IV) with R₅ being an alkylated aromatic group, preferably carrying 6 to 10 carbon atoms, R₆ being a hydrogen atom and n being different from zero.

Advantageously, the mass percentage of the ether is less than 40% relative to the mass of the monophosphoric ester A and the ether.

### Combination of Monophosphoric Ester a and Fatty Acid or Fixed Oil

In certain embodiments, the compound B is a fatty acid or a fixed oil.

Preferably, the component B is a saturated or unsaturated fatty acid having at least 12 carbon atoms.

Preferably, the fatty acid comprises from 12 to 22 carbon atoms, more preferably from 14 to 20 carbon atoms and most preferably from 16 to 18 carbon atoms.

Advantageously, the mass percentage of fatty acid is less than 60%, preferably less than 40%, preferably less than 20% relative to the mass of the monophosphoric ester A and the fatty acid.

When the compound B is a fixed oil, it can be rapeseed oil or sunflower Oil.

Advantageously, the mass percentage of the fixed oil is less than 50%, preferably less than 30%, preferably less than 10% relative to the mass of the monophosphoric ester A and the fixed oil.

According to embodiments, the collector consists of the monophosphoric ester A of formula (I) and the compound B as described above.

The combination of a monophosphoric ester A of formula (I) and a diphosphoric ester leads to a significant reduction in the efficiency of the collector compared to a collector consisting of only the monophosphoric ester A of formula (I).

The collector according to the invention is more efficient than the collectors of the prior art and can be used in smaller amounts.

Advantageously, the amount of monophosphoric ester A and the compound B added during step (i) varies from 100 g to 500 g per tonne of phosphate ores, preferably from 100 g to 300 g, particularly preferably from 120 g/tonne to 260 g/tonne of phosphate ores.

Advantageously, the collectors according to the invention allow to develop their own froth without it being necessary to add an additional frother, such as methyl isobutyl carbinol (MIBC) or pine oil.

Preferably, the method of the present invention does not require the use of an additional frother, pH regulating agent or activating agent during the flotation method.

The suspensions of ores and collectors according to the invention are pH neutral and do not require the addition of a pH regulator. For example, a pH regulating agent is used when fatty acid-based collectors are used.

Furthermore, the use of flotation activators, which can also act as pH regulators, such as sodium hydroxide or sulfuric acid, is not necessary.

According to embodiments, the treatment method according to the invention further comprises a step i′) before step i) of adding a depressant such as phosphoric acid and/or a step i″) between step i) and step ii) of adding an amine compound for the flotation of silicates

Step (i′) of Adding a Depressant

Depressant agents such as phosphoric acid and its derivatives, diphosphonic acid [DPA] and orthophosphoric acid [OPA] may be used.

Step (i″) of Adding an Amine Compound for the Flotation of Silicates

In order to remove silicates from the phosphate ore to be treated, an amine collector such as the products in the FLOTINOR™ and FLOTIGAM™ products can be added to the aqueous suspension from step i).

### Gas Injection Step (ii)

The gas injection step (ii) allows the froth comprising carbonates and heavy metals to float to the surface of the suspension. For this purpose, the gas is injected so as to form homogeneous gas bubbles which, after adsorption with the froth, will transport the froth by flotation to the surface of the suspension.

The gas bubbles can be formed by any means known to the person skilled in the art, for example by a porous base, sintered glass or by one or more injection nozzles.

The gas injected in step (ii) may be air, nitrogen, or any other gas inert to the species present.

The gas injection in step (ii) can be carried out at a constant flow rate. A person skilled in the art will know how to adapt the flow rate of the gas injection.

Step (ii) is carried out with stirring in order to have a homogeneous distribution of the gas bubbles in the aqueous suspension. Stirring can be ensured by any means known to the person skilled in the art, such as for example mechanical stirring such as a rotor or magnetic stirring.

Generally step (ii) can be carried out for a time ranging from 5 seconds to 30 minutes, typically from 5 seconds to 5 minutes.

Separation Step (iii)

The treatment method comprises a step (iii) of separating the froth containing carbonates and heavy metals from the ore suspension.

The recovered froth can eventually be retreated in order to separate and recover the extracted heavy metals.

The treated ore suspension obtained at the end of step (iii) is recovered after removal of the froth.

Typically, the froth is recovered in step (iii) from the upper part of the treated phosphoric acid solution by any means known to the person skilled in the art. For example, the flotation froth may be discharged into a recovery tank.

The efficiency of the method according to the invention is expressed in terms of:
mass percentage of (rejected) floated product expressed in relation to the total mass of dried floated product and concentrate recovered
mass percentages of magnesium oxide (MgO), tricalcium phosphate (BPL or bone phosphate of lime) or P₂O₅ expressed in relation to the total mass of dried concentrate, as well as the cadmium and arsenic content in the concentrate. The BPL content is obtained by multiplying the P₂O₅ content by a correction factor of 2.185.

Typically, the method according to the invention allows to obtain a mass percentage of (rejected) floated product expressed in relation to the total mass of dried floated product and concentrate recovered of less than 25%.

After treatment, the percentage of tricalcium phosphate (BPL or bone phosphate of lime) or P₂O₅ expressed in relation to the total mass of dried concentrate, as well as the cadmium and arsenic content in the concentrate are respectively increased and decreased compared to the non-treated ore.

Advantageously, the percentage of tricalcium phosphate (BPL or bone phosphate of lime) is greater than or equal to 65% after implementing the method according to the invention. Advantageously, the percentage of P₂O₅ is greater than or equal to 30% after implementing the method according to the invention.

Advantageously, the percentage of tricalcium phosphate (BPL or bone phosphate of lime) is greater than or equal to 70% after implementing the method according to the invention. Advantageously, the percentage of P₂O₅ is greater than or equal to 32% after implementing the method according to the invention.

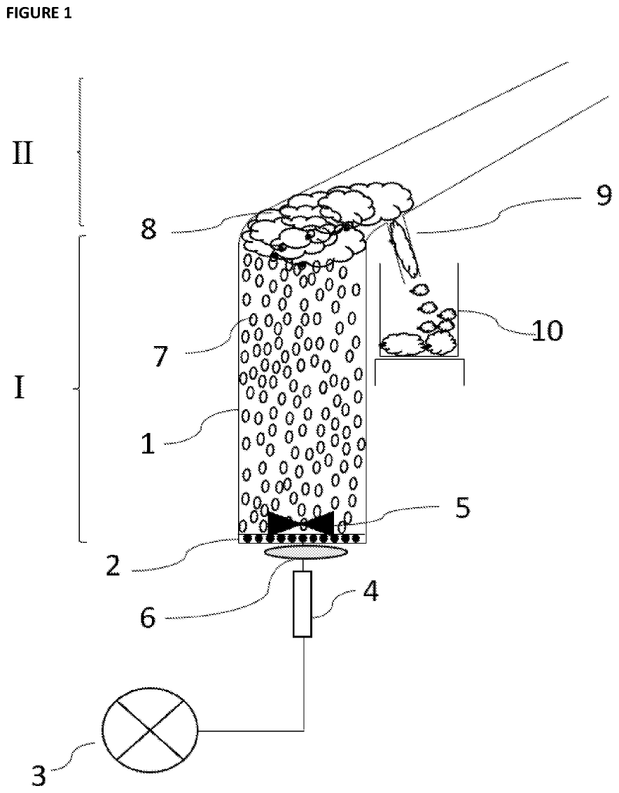

FIG. 1 illustrates in a non-limiting manner devices capable of implementing the flotation treatment method according to the invention.

In certain embodiments, the method according to the invention is implemented in a flotation device, such as a flotation column combined with a froth recovery tank in the upper part of the column, as schematically shown in FIG. 1.

Part I, called the treatment part, comprises the flotation column which consists of a glass column 1 filled with the phosphate ore pulp conditioned with the flotation collector according to the invention. The gas is introduced into the bottom of the column, the gas bubbles are formed by the passage of the gas through the sintered glass 2. The gas is generated by a gas generator 3 and its flow rate is controlled by a flow meter 4. The medium is stirred by a magnetic bar 5 with a magnetic stirrer 6 which allows to obtain a good distribution of the gas bubbles 7. The froth 8 is formed upon contact with the gas bubbles. The froth is then entrained at the top of the column in a froth discharge zone 9 corresponding to part II, called the separation part. The froth 8 then flows into a froth recovery tank 10.

The residence time in the flotation device is generally less than 30 minutes, preferably between 5 seconds and 5 minutes.

The ion flotation treatment method can be carried out at a temperature ranging from 15 to 90° C. or from 20 to 80° C.

Use of Monophosphoric Ester a, Alone or in Combination with Compound B

Another object of the invention relates to the use of monophosphoric ester A, alone or in combination with the compound B as described above for the treatment of phosphate ores containing heavy metals. The use of monophosphoric ester A and the compound B as described above as collector according to the invention allows to have new methods for treating phosphate ores, which are simpler and less expensive, allowing to enrich their P₂O₅ content but also to reduce their content of heavy metals, such as cadmium and arsenic.

The collector according to the invention is more effective than the compositions of the prior art and can be used in smaller amounts.

### EXAMPLES

The following non-restrictive examples illustrate exemplary embodiments of the invention.

Phosphate ore samples were collected from the Khouribga mining site (Bni-Amir). They were crushed, mixed, homogenized, and divided into quarters using a riffle sampler. They were then treated and analyzed.

### 1. Mineralogical Characterization of Phosphate Ore

Characterization and quantification of these samples were performed using different analytical techniques, including atomic absorption and ICP-MS. The results are shown in Table 1.

TABLE 1
Characterization of a sample of phosphate ore from Khouribga

| P₂O₅ (%) | CO₂ (%) | MgO (%) | SiO₂ (%) | Cd (ppm) | As (ppm) |
|---|---|---|---|---|---|
| 28.57 | 8.66 | 0.3 | 6.42 | 27 | 13 |

Phosphate ore comprises heavy metals, particularly cadmium at 27 ppm and arsenic at 13 ppm.

### 2. Synthesis of Monophosphoric Esters

All organic solvents were purchased and used as is, without purification. Chemicals were purchased from Aldrich, Merck and used without any purification. NMR spectra were recorded in deuterated solvent on a Bruker AC 400 spectrometer at 400 MHz for ¹H NMR and at 50 MHz or 101 MHz for ¹³C NMR; 6 is expressed in ppm relative to TMS (0 ppm) as an internal standard for 1H and ¹³C, H₃PO₄ for Phosphorus NMR. Splitting patterns are designated as follows: s (singlet), d (doublet), t (triplet), m (multiplet), br (broad). Coupling constants (values J) are given in Hertz (Hz).

Alcohol (1 eq) is added dropwise to phosphorus(V) oxychloride (1.5 eq) with vigorous stirring at 0° C. for one hour under an inert atmosphere, the reaction mixture is stirred continuously for a period of about 4 to 5 h at room temperature. The obtained monoalkylphosphoryl dichloride is poured dropwise into ice water and stirring is maintained for a few hours (4-16 h). Then, the mixture is extracted with diethyl ether, and the combined organic phases were dried with magnesium sulfate (MgSO₄) and concentrated under reduced pressure, to obtain the appropriate product.

NMR analyses of the reaction product do not allow the presence of the phosphoric acid diester to be detected.

The reaction scheme of the synthesis of monophosphoric ester is illustrated in Scheme 1.

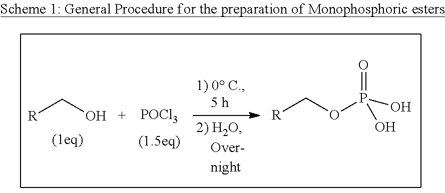

### 3. Method for Treating Ore

### 3.1. Operating Mode

A Denver D-12 flotation cell is used.

200 g of dry sedimentary phosphate ore, ground and sized between 40 μm and 160 μm, are suspended in 1.5 L of water. The pulp is conditioned with 500 g per tonne (g/t) of phosphoric acid (H₃PO₄) as a depressant for 3 min at 1200 rpm, then the collector for carbonate flotation is added at 250 g/t. After 2 min of conditioning, the amine collector “FLOTINOR” for silicate flotation is added at 200 g/t, followed by 30 seconds of conditioning. The flotation process is started immediately after the air injection. The frothering product (floated product) and the concentrate are filtered, dried, weighed and analyzed.

Unless otherwise stated, the treatment method is as described above.

### 3.2. Evaluation of the Different Collectors

The methods preceded by a “C” correspond to comparative examples.

Unless otherwise stated, the percentages given below are mass percentages.

### Example 1: Evaluation of Monophosphoric Esters

Table 2 below shows the results obtained for each collector in terms of:
mass percentage of (rejected) floated product expressed in relation to the total mass of dried floated product and concentrate recovered
mass percentages of magnesium oxide (MgO), tricalcium phosphate (BPL or bone phosphate of lime) or P₂O₅ expressed in relation to the total mass of dried concentrate, as well as the cadmium and arsenic content in the concentrate. The BPL content is obtained by multiplying the P₂O₅ content by a correction factor of 2.185.

TABLE 2

| | | | Flotation | | | | | |
|---|---|---|---|---|---|---|---|---|
| Flotation | Collector | | Recovery (%) | MgO | BPL | P₂O₅ | Cd | As |
| method | Alkyl | content | Floated | (%) | (%) | (%) | (ppm) | (ppm) |
| Reference | Chain | (g/t) | (Rejected) | Content (%) in the concentrate | | | | |
| 1 | C₆ | 250 | 7.43 | 0.29 | 64.92 | 29.70 | — | — |
| 3 | C₈ | 250 | 24.74 | 0.30 | 71.24 | 32.59 | 8 | 4 |
| 4 | C₉ | 125 | 17.27 | 0.28 | 69.56 | 31.83 | — | — |
| 5 | C₁₀ | 250 | 6.68 | 0.29 | 66.59 | 30.47 | — | — |
| C-6 | C₁₂ | 250 | 0.00 | 0.30 | 62.43 | 28.57 | 27 | 13 |
| C-7 | C₁₄ | 250 | 0.00 | 0.30 | 62.43 | 28.57 | 27 | 13 |
| C-8 | C_{18(Oleyl)} | 250 | 0.00 | 0.30 | 62.43 | 28.57 | 27 | 13 |

The Mono-Octylphosphoric ester collector at a concentration of 250 g/t allows to obtain a BPL content of 71.24 (32.59% of P₂O₅) with a loss of 24.74% by weight. The Mono-Nonylphosphoric ester collector allows to obtain a BPL content of 69.56 (31.83% of P₂O₅) with a loss of 17.27% by weight for a concentration of only 125 g/t.

Long chain alkyl collectors have no effect on flotation (method not forming part of the invention).

After treatment, the Cadmium content is reduced by 75% and the Arsenic content is reduced by 70%.

### Example 2: Evaluation of the Combination of Monophosphoric Esters

As illustrated in Tables 3 to 6 below, the combination of two monophosphoric esters allows to optimize the amount of float rejected while obtaining a concentrate enriched in P₂O₅.

Tables 3 to 6 illustrate the effect of combining the ester with a linear C8 chain and an ester with a branched chain.

TABLE 3

| | | | Flotation | | | | | |
|---|---|---|---|---|---|---|---|---|
| Flotation | | | Recovery (%) | MgO | BPL | P₂O₅ | Cd | As |
| method | Collector | | Floated | (%) | (%) | (%) | (ppm) | (ppm) |
| Reference | Composition | | (Rejected) | Content (%) in the concentrate | | | | |
| 1 | Octyl | — | 24.74 | 0.30 | 71.24 | 32.59 | 8 | 4 |
| | Phosphate | | | | | | | |
| | (100%) | | | | | | | |
| 2 | Octyl | 2-ethylhexyl | 18.20 | 0.36 | 70.12 | 32.08 | 7 | 4 |
| | Phosphate | Phosphate | | | | | | |
| | (80%) | (20%) | | | | | | |
| 3 | Octyl | 2-ethylhexyl | 16.78 | 0.33 | 68.02 | 31.12 | — | — |
| | Phosphate | Phosphate | | | | | | |
| | (60%) | (40%) | | | | | | |
| 4 | Octyl | 2-ethylhexyl | 14.56 | 0.33 | 67.68 | 30.97 | — | — |
| | Phosphate | Phosphate | | | | | | |
| | (50%) | (50%) | | | | | | |
| 5 | Octyl | 2-ethylhexyl | 14.78 | 0.34 | 69.36 | 31.74 | — | — |
| | Phosphate | Phosphate | | | | | | |
| | (40%) | (60%) | | | | | | |
| 6 | Octyl | 2-ethylhexyl | 14.38 | 0.36 | 69.05 | 31.59 | — | — |
| | Phosphate | Phosphate | | | | | | |
| | (20%) | (80%) | | | | | | |
| 7 | — | 2-ethylhexyl | 11.93 | 0.34 | 68.97 | 31.56 | — | — |
| | | Phosphate | | | | | | |
| | | (100%) | | | | | | |

TABLE 4

| | | | Flotation | | | | | |
|---|---|---|---|---|---|---|---|---|
| Flotation | | | Recovery (%) | MgO | BPL | P₂O₅ | Cd | As |
| method | Collector | | Floated | (%) | (%) | (%) | (ppm) | (ppm) |
| Reference | Composition | | (Rejected) | Content (%) in the concentrate | | | | |
| 1 | Octyl | — | 24.74 | 0.30 | 71.24 | 32.59 | 8 | 4 |
| | Phosphate | | | | | | | |
| | (100%) | | | | | | | |
| 2 | Octyl | 2,4,4- | 16.30 | 0.34 | 70.22 | 32.13 | 7 | 4 |
| | Phosphate | trimethylpentyl | | | | | | |
| | (80%) | phosphate | | | | | | |
| | | (20%) | | | | | | |
| 3 | Octyl | 2,4,4- | 14.66 | — | 70.36 | 32.19 | 7 | 4 |
| | Phosphate | trimethylpentyl | | | | | | |
| | (60%) | phosphate | | | | | | |
| | | (40%) | | | | | | |
| 4 | Octyl | 2,4,4- | 12.93 | 0.46 | 69.03 | 31.58 | — | — |
| | Phosphate | trimethylpentyl | | | | | | |
| | (50%) | phosphate | | | | | | |
| | | (50%) | | | | | | |
| 5 | Octyl | 2,4,4- | 11.66 | 0.31 | 67.18 | 30.74 | — | — |
| | Phosphate | trimethylpentyl | | | | | | |
| | (40%) | phosphate | | | | | | |
| | | (60%) | | | | | | |
| 6 | Octyl | 2,4,4- | 11.33 | 0.31 | 69.08 | 31.61 | — | — |
| | Phosphate | trimethylpentyl | | | | | | |
| | (20%) | phosphate | | | | | | |
| | | (80%) | | | | | | |
| 7 | — | 2,4,4- | 9.67 | 0.31 | 66.55 | 30.45 | — | — |
| | | trimethylpentyl | | | | | | |
| | | phosphate | | | | | | |
| | | (100%) | | | | | | |

TABLE 5

| | | | Flotation | | | | | |
|---|---|---|---|---|---|---|---|---|
| Flotation | | | Recovery (%) | MgO | BPL | P₂O₅ | Cd | As |
| method | Collector | | Floated | (%) | (%) | (%) | (ppm) | (ppm) |
| Reference | Composition | | (Rejected) | Content (%) in the concentrate | | | | |
| 1 | Octyl | — | 24.74 | 0.30 | 71.24 | 32.59 | 8 | 4 |
| | Phosphate | | | | | | | |
| | (100%) | | | | | | | |
| 2 | Octyl | 3,5,5- | 21.32 | 0.32 | 70.35 | 32.19 | 7 | 4 |
| | Phosphate | trimethylhexyl | | | | | | |
| | (80%) | Phosphate | | | | | | |
| | | (20%) | | | | | | |
| 3 | Octyl | 3,5,5- | 19.99 | 0.32 | 69.07 | 31.60 | — | — |
| | Phosphate | trimethylhexyl | | | | | | |
| | (60%) | Phosphate | | | | | | |
| | | (40%) | | | | | | |
| 4 | Octyl | 3,5,5- | 20.81 | 0.32 | 70.02 | 32.04 | 8 | 4 |
| | Phosphate | trimethylhexyl | | | | | | |
| | (50%) | Phosphate | | | | | | |
| | | (50%) | | | | | | |
| 5 | Octyl | 3,5,5- | 23.89 | 0.31 | 70.29 | 32.16 | 8 | 4 |
| | Phosphate | trimethylhexyl | | | | | | |
| | (40%) | Phosphate | | | | | | |
| | | (60%) | | | | | | |
| 6 | Octyl | 3,5,5- | 23.48 | 0.41 | 70.05 | 32.05 | 8 | 4 |
| | Phosphate | trimethylhexyl | | | | | | |
| | (20%) | Phosphate | | | | | | |
| | | (80%) | | | | | | |
| 7 | — | 3,5,5- | 21.10 | 0.32 | 68.59 | 31.38 | — | — |
| | | trimethylhexyl | | | | | | |
| | | Phosphate | | | | | | |
| | | (100%) | | | | | | |

TABLE 6

| | | | Flotation | | | | | |
|---|---|---|---|---|---|---|---|---|
| Flotation | | | Recovery (%) | MgO | BPL | P₂O₅ | Cd | As |
| method | Collector | | Floated | (%) | (%) | (%) | (ppm) | (ppm) |
| Reference | Composition | | (Rejected) | Content (%) in the concentrate | | | | |
| 1 | Decyl | — | 6.68 | 0.29 | 66.59 | 30.47 | — | — |
| | Phosphate | | | | | | | |
| | (100%) | | | | | | | |
| 2 | Decyl | Hexyl | 8.88 | 0.32 | 66.86 | 30.59 | — | — |
| | Phosphate | Phosphate | | | | | | |
| | (90%) | (10%) | | | | | | |
| 3 | Decyl | Hexyl | 8.88 | 0.31 | 67.25 | 30.77 | — | — |
| | Phosphate | Phosphate | | | | | | |
| | (80%) | (20%) | | | | | | |
| 4 | Decyl | Hexyl | 8.39 | 0.30 | 67.60 | 30.93 | — | — |
| | Phosphate | Phosphate | | | | | | |
| | (70%) | (30%) | | | | | | |
| 5 | Decyl | Hexyl | 16.46 | 0.28 | 68.41 | 31.30 | — | — |
| | Phosphate | Phosphate | | | | | | |
| | (60%) | (40%) | | | | | | |
| 6 | Decyl | Hexyl | 12.50 | 0.29 | 67.88 | 31.06 | — | — |
| | Phosphate | Phosphate | | | | | | |
| | (50%) | (50%) | | | | | | |
| 7 | Decyl | Hexyl | 12.87 | 0.30 | 68.10 | 31.16 | — | — |
| | Phosphate | Phosphate | | | | | | |
| | (40%) | (60%) | | | | | | |
| 8 | Decyl | Hexyl | — | — | — | — | — | — |
| | Phosphate | Phosphate | | | | | | |
| | (30%) | (70%) | | | | | | |
| 9 | Decyl | Hexyl | 8.91 | 0.29 | 67.89 | 31.06 | — | — |
| | Phosphate | Phosphate | | | | | | |
| | (20%) | (80%) | | | | | | |
| 10 | Decyl | Hexyl | 7.12 | 0.28 | 65.43 | 29.94 | — | — |
| | Phosphate | Phosphate | | | | | | |
| | (10%) | (90%) | | | | | | |
| 11 | — | Hexyl | 7.43 | 0.29 | 64.92 | 29.70 | — | — |
| | | Phosphate | | | | | | |
| | | (100%) | | | | | | |

### Example 3: Evaluation of the Combination of a Monophosphoric Ester and an Alcohol

Table 7 illustrates the effect of combining a monophosphoric ester and an alcohol.

TABLE 7

| | | | Flotation | | | | | |
|---|---|---|---|---|---|---|---|---|
| Flotation | | | Recovery (%) | MgO | BPL | P₂O₅ | Cd | As |
| method | Collector | | Floated | (%) | (%) | (%) | (ppm) | (ppm) |
| Reference | Composition | | (Rejected) | Content (%) in the concentrate | | | | |
| 1 | Octyl | — | 23.29 | 0.33 | 71.32 | 32.64 | 8 | 4 |
| | Phosphate | | | | | | | |
| | (100%) | | | | | | | |
| 2 | Octyl | 1-Octanol | 19.56 | 0.34 | 70.61 | 32.31 | 8 | 4 |
| | Phosphate | (10%) | | | | | | |
| | (90%) | | | | | | | |
| 3 | Octyl | 1-Octanol | 15.59 | 0.34 | 69.85 | 31.96 | — | — |
| | Phosphate | (20%) | | | | | | |
| | (80%) | | | | | | | |
| 4 | Octyl | 1-Octanol | 15.04 | 0.34 | 69.82 | 31.94 | — | — |
| | Phosphate | (30%) | | | | | | |
| | (70%) | | | | | | | |
| 5 | Octyl | 1-Octanol | 11.20 | 0.36 | 68.25 | 31.23 | — | — |
| | Phosphate | (40%) | | | | | | |
| | (60%) | | | | | | | |
| 6 | Octyl | 1-Octanol | 10.20 | 0.35 | 64.49 | 29.51 | — | — |
| | Phosphate | (50%) | | | | | | |
| | (50%) | | | | | | | |
| 7 | Octyl | 1-Octanol | 5.73 | 0.33 | 65.25 | 29.86 | — | — |
| | Phosphate | (60%) | | | | | | |
| | (40%) | | | | | | | |
| 8 | Octyl | 1-Octanol | 4.69 | 0.35 | 64.45 | 29.49 | — | — |
| | Phosphate | (70%) | | | | | | |
| | (30%) | | | | | | | |
| 9 | Octyl | 1-Octanol | 1.39 | 0.37 | 63.28 | 28.95 | — | — |
| | Phosphate | (80%) | | | | | | |
| | (20%) | | | | | | | |
| 10 | Octyl | 1-Octanol | 4.19 | 0.36 | 64.13 | 29.34 | — | — |
| | Phosphate | (90%) | | | | | | |
| | (10%) | | | | | | | |
| 11 | — | 1-Octanol | 0.84 | 0.36 | 62.95 | 28.80 | — | — |
| | | (100%) | | | | | | |

For compositions comprising less than 30% by mass of octanol, a P₂O₅ content greater than or equal to 32% is obtained for the treated ore.

### Example 4: Evaluation of the Combination of a Monophosphoric Ester and a Sulfate

Table 8 illustrates the effect of combining a monophosphoric ester and a sulfate.

TABLE 8

| | | | Flotation | | | | | |
|---|---|---|---|---|---|---|---|---|
| Flotation | | | Recovery (%) | MgO | BPL | P₂O₅ | Cd | As |
| method | Collector | | Floated | (%) | (%) | (%) | (ppm) | (ppm) |
| Reference | Composition | | (Rejected) | Content (%) in the concentrate | | | | |
| 1 | Octyl | — | 23.29 | 0.33 | 71.32 | 32.64 | 8 | 4 |
| | Phosphate | | | | | | | |
| | (100%) | | | | | | | |
| 2 | Octyl | Sodium | 17.88 | 0.30 | 70.59 | 32.30 | 8 | 4 |
| | Phosphate | dodecyl | | | | | | |
| | (90%) | sulfate | | | | | | |
| | | (10%) | | | | | | |
| 3 | Octyl | Sodium | 16.63 | 0.31 | 70.39 | 32.21 | 9 | 4 |
| | Phosphate | dodecyl | | | | | | |
| | (80%) | sulfate | | | | | | |
| | | (20%) | | | | | | |
| 4 | Octyl | Sodium | 11.20 | 0.28 | 69.29 | 31.70 | — | — |
| | Phosphate | dodecyl | | | | | | |
| | (70%) | sulfate | | | | | | |
| | | (30%) | | | | | | |
| 5 | Octyl | Sodium | 8.91 | 0.3 | 67.84 | 31.04 | — | — |
| | Phosphate | dodecyl | | | | | | |
| | (60%) | sulfate | | | | | | |
| | | (40%) | | | | | | |
| 6 | Octyl | Sodium | 5.29 | 0.29 | 67.02 | 30.66 | — | — |
| | Phosphate | dodecyl | | | | | | |
| | (50%) | sulfate | | | | | | |
| | | (50%) | | | | | | |
| 7 | Octyl | Sodium | 3.59 | 0.28 | 65.3 | 29.88 | — | — |
| | Phosphate | dodecyl | | | | | | |
| | (40%) | sulfate | | | | | | |
| | | (60%) | | | | | | |
| C-8 | Octyl | Sodium | 0.00 | 0.30 | 62.43 | 28.57 | 27 | 13 |
| | Phosphate | dodecyl | | | | | | |
| | (30%) | sulfate | | | | | | |
| | | (70%) | | | | | | |
| C-9 | Octyl | Sodium | 0.00 | 0.30 | 62.43 | 28.57 | 27 | 13 |
| | Phosphate | dodecyl | | | | | | |
| | (20%) | sulfate | | | | | | |
| | | (80%) | | | | | | |
| C-10 | Octyl | Sodium | 0.00 | 0.30 | 62.43 | 28.57 | 27 | 13 |
| | Phosphate | dodecyl | | | | | | |
| | (10%) | sulfate | | | | | | |
| | | (90%) | | | | | | |
| C-11 | — | Sodium | 0.00 | 0.30 | 62.43 | 28.57 | 27 | 13 |
| | | dodecyl | | | | | | |
| | | sulfate | | | | | | |
| | | (100%) | | | | | | |

For compositions comprising less than 20% by mass of sulfate, a BPL content greater than or equal to 32% is obtained for the treated ore.

### Example 5: Evaluation of the Combination of a Monophosphoric Ester and a Fatty Acid

Table 9 illustrates the effect of combining a monophosphoric ester and a fatty acid.

TABLE 9

| | | | Flotation | | | | | |
|---|---|---|---|---|---|---|---|---|
| Flotation | | | Recovery (%) | MgO | BPL | P₂O₅ | Cd | As |
| method | Collector | | Floated | (%) | (%) | (%) | (ppm) | (ppm) |
| Reference | Composition | | (Rejected) | Content (%) in the concentrate | | | | |
| 1 | Octyl | — | 23.29 | 0.33 | 71.32 | 32.64 | 8 | 4 |
| | Phosphate | | | | | | | |
| | (100%) | | | | | | | |
| 2 | Octyl | Linoleic | 12.13 | 0.29 | 66.55 | 30.45 | — | — |
| | Phosphate | Acid | | | | | | |
| | (80%) | (20%) | | | | | | |
| 3 | Octyl | Linoleic | 8.93 | 0.30 | 64.79 | 29.64 | — | — |
| | Phosphate | Acid | | | | | | |
| | (60%) | (40%) | | | | | | |
| 4 | Octyl | Linoleic | 5.97 | 0.30 | 64.77 | 29.63 | — | — |
| | Phosphate | Acid | | | | | | |
| | (50%) | (50%) | | | | | | |
| 5 | Octyl | Linoleic | 4.64 | 0.31 | 64.03 | 29.30 | — | — |
| | Phosphate | Acid | | | | | | |
| | (40%) | (60%) | | | | | | |
| 6 | Octyl | Linoleic | 3.10 | 0.32 | 62.67 | 28.67 | — | — |
| | Phosphate | Acid | | | | | | |
| | (20%) | (80%) | | | | | | |
| C-7 | — | Linoleic | 0.00 | 0.30 | 62.43 | 28.57 | 27 | 13 |
| | | Acid | | | | | | |
| | | (100%) | | | | | | |

### Example 6: Evaluation of the Combination of a Monophosphoric Ester and an Oil

Table 10 illustrates the effect of combining a monophosphoric ester and an oil.

TABLE 10

| | | | Flotation | | | | | |
|---|---|---|---|---|---|---|---|---|
| Flotation | | | Recovery (%) | MgO | BPL | P₂O₅ | Cd | As |
| method | Collector | | Floated | (%) | (%) | (%) | (ppm) | (ppm) |
| Reference | Composition | | (Rejected) | Content (%) in the concentrate | | | | |
| 1 | Octyl | — | 23.29 | 0.33 | 71.32 | 32.64 | 8 | 4 |
| | Phosphate | | | | | | | |
| | (100%) | | | | | | | |
| 2 | Octyl | Sunflower | 13.30 | 0.3 | 68.98 | 31.56 | | |
| | Phosphate | Oil | | | | | | |
| | (90%) | (10%) | | | | | | |
| 3 | Octyl | Sunflower | 11.34 | 0.29 | 69.30 | 31.71 | — | — |
| | Phosphate | Oil | | | | | | |
| | (80%) | (20%) | | | | | | |
| 4 | Octyl | Sunflower | 10.20 | 0.29 | 67.50 | 30.88 | — | — |
| | Phosphate | Oil | | | | | | |
| | (70%) | (30%) | | | | | | |
| 5 | Octyl | Sunflower | 6.59 | 0.29 | 65.12 | 29.79 | — | — |
| | Phosphate | Oil | | | | | | |
| | (60%) | (40%) | | | | | | |
| 6 | Octyl | Sunflower | 5.73 | 0.29 | 64.34 | 29.44 | — | — |
| | Phosphate | Oil | | | | | | |
| | (50%) | (50%) | | | | | | |
| 7 | Octyl | Sunflower | 4.58 | 0.30 | 63.05 | 28.85 | — | — |
| | Phosphate | Oil | | | | | | |
| | (40%) | (60%) | | | | | | |
| C-8 | Octyl | Sunflower | 0.00 | 0.30 | 62.43 | 28.57 | 27 | 13 |
| | Phosphate | Oil | | | | | | |
| | (30%) | (70%) | | | | | | |
| C-9 | Octyl | Sunflower | 0.00 | 0.30 | 62.43 | 28.57 | 27 | 13 |
| | Phosphate | Oil | | | | | | |
| | (20%) | (80%) | | | | | | |
| C-10 | Octyl | Sunflower | 0.00 | 0.30 | 62.43 | 28.57 | 27 | 13 |
| | Phosphate | Oil | | | | | | |
| | (10%) | (90%) | | | | | | |
| C-11 | — | Sunflower | 0.00 | 0.30 | 62.43 | 28.57 | 27 | 13 |
| | | Oil | | | | | | |
| | | (100%) | | | | | | |

### Example 7: Evaluation of the Combination of a Monophosphoric Ester and a Sulfonate

Table 11 illustrates the effect of combining a monophosphoric ester and a sulfonate.

TABLE 11

| | | | Flotation | | | | | |
|---|---|---|---|---|---|---|---|---|
| Flotation | | | Recovery (%) | MgO | BPL | P₂O₅ | Cd | As |
| method | Collector | | Floated | (%) | (%) | (%) | (ppm) | (ppm) |
| Reference | Composition | | (Rejected) | Content (%) in the concentrate | | | | |
| 1 | Octyl | — | 23.29 | 0.33 | 71.32 | 32.64 | 8 | 4 |
| | Phosphate | | | | | | | |
| | (100%) | | | | | | | |
| 3 | Octyl | Dodecylbenzene | 16.01 | 0.30 | 71.07 | 32.52 | 8 | 4 |
| | Phosphate | sulfonic acid | | | | | | |
| | (80%) | (20%) | | | | | | |
| 5 | Octyl | Dodecylbenzene | 12.56 | 0.30 | 70.03 | 32.04 | 8 | 4 |
| | Phosphate | sulfonic acid | | | | | | |
| | (60%) | (40%) | | | | | | |

### Example 8: Evaluation of the Combination of a Monophosphoric Ester and an Ether Pegylated

Table 12 illustrates the effect of combining a monophosphoric ester and a pegylated ether.

TABLE 12

| | | | Flotation | | | | | |
|---|---|---|---|---|---|---|---|---|
| Flotation | | | Recovery (%) | MgO | BPL | P₂O₅ | Cd | As |
| method | Collector | | Floated | (%) | (%) | (%) | (ppm) | (ppm) |
| Reference | Composition | | (Rejected) | Content (%) in the concentrate | | | | |
| 1 | Octyl | — | 23.29 | 0.33 | 71.32 | 32.64 | 8 | 4 |
| | Phosphate | | | | | | | |
| | (100%) | | | | | | | |
| 2 | Octyl | IGEPAL | 22.83 | 0.32 | 71.38 | 32.66 | 7 | 4 |
| | Phosphate | CA-630 | | | | | | |
| | (90%) | (10%) | | | | | | |
| 3 | Octyl | IGEPAL | 20.69 | 0.32 | 70.72 | 32.36 | 8 | 4 |
| | Phosphate | CA-630 | | | | | | |
| | (80%) | (20%) | | | | | | |
| 4 | Octyl | IGEPAL | 18.00 | 0.31 | 70.99 | 32.48 | 8 | 4 |
| | Phosphate | CA-630 | | | | | | |
| | (70%) | (30%) | | | | | | |
| 5 | Octyl | IGEPAL | 18.16 | 0.32 | 68.98 | 31.56 | — | — |
| | Phosphate | CA-630 | | | | | | |
| | (60%) | (40%) | | | | | | |

### Example 9: Evaluation of the Combination of a Monophosphoric Ester and a Diphosphoric Ester

Characterization and quantification of the phosphate ore samples used for Example 9 were performed using the techniques described above, including atomic absorption and ICP-MS. The results are shown in Table 13 below.

TABLE 13
Characterization of the ore sample used for example 9

| P₂O₅ (%) | CO₂ (%) | MgO (%) | SiO₂ (%) | Cd (ppm) |
|---|---|---|---|---|
| 21.83 | 8.85 | 1.84 | 22.62 | 15 |

Phosphate ore contains heavy metals, especially cadmium at 15 ppm.

The monoester of phosphoric acid is octylphosphate (mono-octylphosphoric ester). The diester of phosphoric acid is dioctylphosphate (dioctylphosphoric ester).

The phosphate ore is treated as described in paragraph 3.1.

Table 14 shows the effect of combining the monoester with a linear C8 chain and a diester with linear C8 chains.

TABLE 14

| | | | Flotation | | | | |
|---|---|---|---|---|---|---|---|
| Flotation | | | Recovery (%) | MgO | BPL | P₂O₅ | Cd |
| method | Collector | | Floated | (%) | (%) | (%) | (ppm) |
| Reference | Composition | | (Rejected) | Content (%) in the concentrate | | | |
| 1 | Octyl | — | 24.70 | 0.33 | 71.32 | 32.64 | 8 |
| | Phosphate | | | | | | |
| | (100%) | | | | | | |
| 2 | Octyl | Dioctyl | 25.81 | 1.00 | 61.37 | 28.09 | 15 |
| | Phosphate | Phosphate | | | | | |
| | (95%) | (5%) | | | | | |
| 3 | Octyl | Dioctyl | 26.23 | 1.00 | 62.09 | 28.42 | 16 |
| | Phosphate | Phosphate | | | | | |
| | (90%) | (10%) | | | | | |
| 3 | Octyl | Dioctyl | 27.76 | 0.90 | 62.40 | 28.56 | 17 |
| | Phosphate | Phosphate | | | | | |
| | (80%) | (20%) | | | | | |
| 4 | Octyl | Dioctyl | 28.04 | 0.93 | 64.24 | 29.40 | 15 |
| | Phosphate | Phosphate | | | | | |
| | (60%) | (40%) | | | | | |
| 5 | Octyl | Dioctyl | 24.53 | 1.21 | 61.38 | 28.09 | 15 |
| | Phosphate | Phosphate | | | | | |
| | (40%) | (60%) | | | | | |
| 6 | Octyl | Dioctyl | 21.69 | 1.60 | 59.44 | 27.20 | 15 |
| | Phosphate | Phosphate | | | | | |
| | (20%) | (80%) | | | | | |
| 7 | — | Dioctyl | 17.45 | 1.91 | 56.37 | 25.80 | 15 |
| | | Phosphate | | | | | |
| | | (100%) | | | | | |

The presence of diester in the collector leads to a decrease in efficiency.

1. A method for treating phosphate ores containing heavy metals by reverse flotation, the method comprising the following steps:
(i) adding, to an aqueous suspension of phosphate ore, a monophosphoric ester A of formula (I): 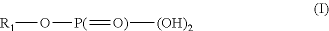
wherein R₁ is a saturated or unsaturated, linear or branched hydrocarbon chain, comprising 6 to 10 carbon atoms,
alone or mixed with a compound B chosen from the group consisting of:
a monophosphoric ester of formula (II) 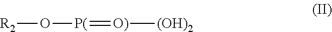
wherein R₂ is a saturated or unsaturated, linear or branched hydrocarbon chain, comprising 6 to 18 carbon atoms, different from the group R₁ of the monophosphoric ester A of formula (I),
an alcohol,
a fatty acid,
a fixed oil,
a sulfate,
a sulfonate,
an ether, and
mixtures thereof;
(ii) injecting gas into the aqueous suspension to form froth; and
(iii) removing froth and recovering the treated ore aqueous suspension.

2. The method according to claim 1, wherein the group R₁ of the monophosphoric ester A of formula (I) is a linear alkyl group comprising 8 or 9 carbon atoms or a branched alkyl group comprising 8 or 9 carbon atoms.

3. The method according to claim 1, wherein compound B, when present, is an alcohol of formula R₃—OH (III), R₃ being a saturated or unsaturated, linear or branched hydrocarbon chain comprising 2 to 20 carbon atoms.

4. The method according to claim 1, wherein compound B, when present, is:
a salt of a hydrocarbon chain sulfonic acid, or a salt of an aromatic sulfonic acid substituted by a hydrocarbon chain, the hydrocarbon chain being saturated or unsaturated, linear or branched comprising 2 to 20 carbon atoms;
or is a hydrocarbon chain sulfate, the hydrocarbon chain being saturated or unsaturated, linear or branched, comprising 2 to 20 carbon atoms.

5. The method according to claim 1, wherein compound B, when present, is an ether, pegylated or not, of formula R₅—(OC₂H₄)ₙO—R₆ (IV) with R₅ being an alkyl or aromatic or alkylated aromatic group and R₆ being an alkyl group or a hydrogen atom and n represents an integer ranging from 0 to 10.

6. The method according to claim 1 or claim 2, wherein the amount of monophosphoric ester A and the compound B added during step (i) ranges from 100 g to 500 g per ton of phosphate ores.

7. The method according to claim 1, wherein it further comprises a step i′) before step i) of adding a depressant and/or a step i″) between step i) and step ii) of adding an amine compound for the flotation of silicates.

8. A method comprising using monophosphoric ester A alone or in combination with compound B as described in claim 1 for the treatment of phosphate ores containing heavy metals.

9. The method according to claim 1 wherein R₁ is an alkyl group.

10. The method according to claim 1 wherein R₂ is an alkyl group.

11. The method according to claim 3 wherein R₃ comprises 6 to 10 carbon atoms.

12. The method according to claim 3 wherein R₃ is an alkyl group.

13. The method according to claim 4 wherein the hydrocarbon chain is an alkyl group.

14. The method according to claim 4 wherein compound B is the sodium salt of dodecyl benzene sulfonic acid.

15. The method according to claim 4 wherein compound B is sodium dodecyl sulfate.

16. The method according to claim 6, wherein the amount of monophosphoric ester A and the compound B added during step (i) ranges from 100 g to 300 g per ton of phosphate ores.

17. The method according to claim 7 wherein the depressant added in step i′) is phosphoric acid.
